(19) United States
(12) Patent Application Publication
(10) Pub. No.: US 2007/0107286 A1
(43) Pub. Date: May 17, 2007

(54) Self-standing collapsible portable structure and method

(76) Inventor: Maya P. Jedlicka, Plano, TX (US)

Correspondence Address: DOCKET CLERK, P.O. DRAWER 800889, DALLAS, TX, 75380, US

(21) Appl. No.: 11/496,752

(22) Filed: Aug. 1, 2006

Related U.S. Application Data
(60) Provisional application No. 60/704,481, filed on Aug. 1, 2005.

(51) Int. Cl. G09F 15/00

(52) U.S. Cl. 40/610

(57) ABSTRACT

A collapsible portable structure and method for same that includes at least three collapsible frame members, a resilient material substantially covering each collapsible frame member to form a side panel for each collapsible frame member, and a hinge portion hingedly connecting each of the collapsible frame members. Each collapsible frame member has a collapsed position and an expanded position. Each collapsible frame member has three or more edges defining a continuous loop in the expanded position. A first edge of each collapsible frame member is hingedly connected to a second edge of a first adjacent frame member, and the second edge of each collapsible frame member is hingedly connected to the first edge of a second adjacent frame member. The collapsible frame members and their associated side panels are connected together such that an interior space is formed between the side panels and a third edge of each collapsible frame member substantially rests on the surface to support the collapsible portable structure.

### CROSS REFERENCE TO RELATED APPLICATIONS

The present document claims the benefit of the earlier filing date of co-pending U.S. provisional patent application Ser. No. 60/704,481, entitled “Self-Standing Collapsible Portable Structure and Method,” filed in the U.S. Patent and Trademark Office on Aug. 1, 2005, hereby incorporated by reference, having common inventors as the present document.

### BACKGROUND OF THE INVENTION

1. Field of the Invention

The present invention relates to collapsible structures and more particularly to self-standing collapsible portable structures having resilient panels supported by collapsible frame members, and a method for using same. The collapsible frame structures may be positioned into either an expanded position or a collapsed position to reduce the structure's overall size.

2. Discussion of the Background

Prior art self-standing structures that have been used to provide information, advertisements, general messages and/or warning messages have suffered from several drawbacks. One drawback with such structures is the difficulty associated with erecting and stably supporting such structures. Another drawback associated with these prior art structures is that the construction of such structures tends to be complicated and bulky. As a result, such structures have been expensive to manufacture and are troublesome to fold away and to store. A further drawback of such prior art structures is that the size, weight and complexity of such structures make them difficult to carry and quickly deploy. Thus, the prior art structures that have been used to provide information, advertisements, general messages and/or warning messages have not been successful in providing a simple structure which is inexpensive to manufacture, is lightweight and easy to carry, is quick and easy to erect, and is quick and easy to collapse into a compact size.

### SUMMARY OF THE INVENTION

Accordingly, one aspect of the present invention may include a collapsible portable structure that includes at least three collapsible frame members, a resilient material substantially covering each collapsible frame member to form a side panel for each collapsible frame member, and a hinge portion hingedly connecting each of the collapsible frame members. Each collapsible frame member has a collapsed position and an expanded position. Each collapsible frame member has three or more edges defining a continuous loop in the expanded position. A first edge of each collapsible frame member is hingedly connected to a second edge of a first adjacent frame member, and the second edge of each collapsible frame member is hingedly connected to the first edge of a second adjacent frame member. The collapsible frame members and their associated side panels are connected together such that an interior space is formed between the side panels, and a third edge of each collapsible frame member substantially rests on the surface to support the collapsible portable structure. At least one side panel includes a message area portion.

Another aspect of the present invention may include a collapsible portable structure that includes at least three collapsible frame members, a resilient material substantially covering each collapsible frame member to form a side panel for each collapsible frame member, and means for connecting each collapsible frame member to adjacent collapsible frame members. Each collapsible frame member has a collapsed position and an expanded position. Each collapsible frame member defines a continuous loop in the expanded position. The collapsible frame members and their associated side panels are connected together such that an interior space is formed between the side panels, and a third edge of each collapsible frame member substantially rests on the surface to support the collapsible portable structure. At least one side panel includes a message area portion.

Yet another aspect of the present invention may include a method for providing notice of a condition using a collapsible portable structure. The method includes a first user carrying a collapsible portable structure, observing a condition requiring a message, deploying the carried collapsible portable structure, and notifying a second user of the condition. The collapsible portable structure includes at least three collapsible frame members, a resilient material substantially covering each collapsible frame member to form a side panel for each collapsible frame member, and means for connecting each collapsible frame member to adjacent collapsible frame members. Each collapsible frame member defines a continuous loop. At least one side panel includes a message area portion. Each collapsible frame member has a collapsed position and an expanded position. The collapsible portable structure is carried in the collapsed position at all relevant times by the first user. In the expanded position, the collapsible frame members and their associated side panels are connected together such that an interior space is formed between the side panels, and a third edge of each collapsible frame member substantially rests on the surface to support the collapsible portable structure. The second user is notified of the condition with a message displayed on the message area portion.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a perspective view of a collapsible portable structure according to an embodiment of the present invention;

FIG. 2 is an elevation side view of a collapsible portable structure according to an embodiment of the present invention;

FIG. 3 is a perspective top view of a collapsible portable structure according to an embodiment of the present invention;

FIG. 4A is an illustration of a collapsible portable structure showing a first transition position according to an embodiment of the present invention;

FIG. 4B is an illustration of a collapsible portable structure showing a second transition position according to an embodiment of the present invention;

FIG. 4C is an illustration of a collapsible portable structure showing a third transition position according to an embodiment of the present invention;

FIG. 4D is an illustration of a collapsible portable structure fully collapsed according to an embodiment of the present invention;

FIG. 5 is a section view partially broken away showing collapsible frame members according to an embodiment of the present invention;

FIG. 6 is cross-sectional side view of a collapsible portable structure showing collapsible frame members according to an embodiment of the present invention;

FIGS. 7A and 7B are elevation side views of a collapsible portable structure showing a detachable message area portion according to another embodiment of the present invention;

FIG. 7C is an elevation side view of a collapsible portable structure showing a detachable message area portion according to yet another embodiment of the present invention; and

FIG. 8 is a flow chart illustrating a process for using the collapsible portable structure according to an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

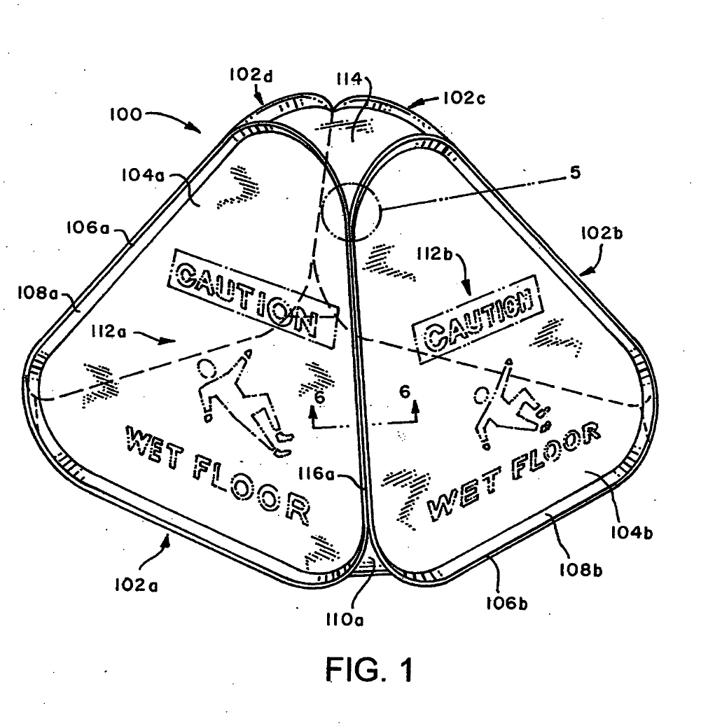

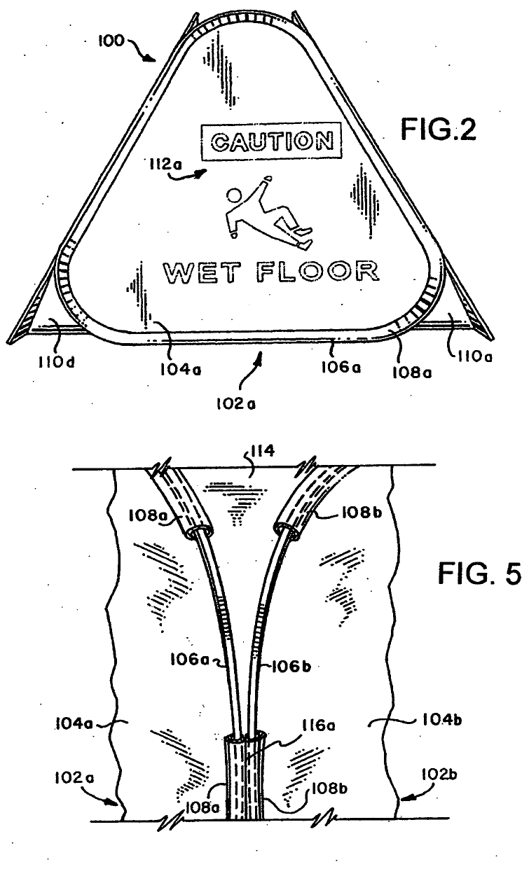

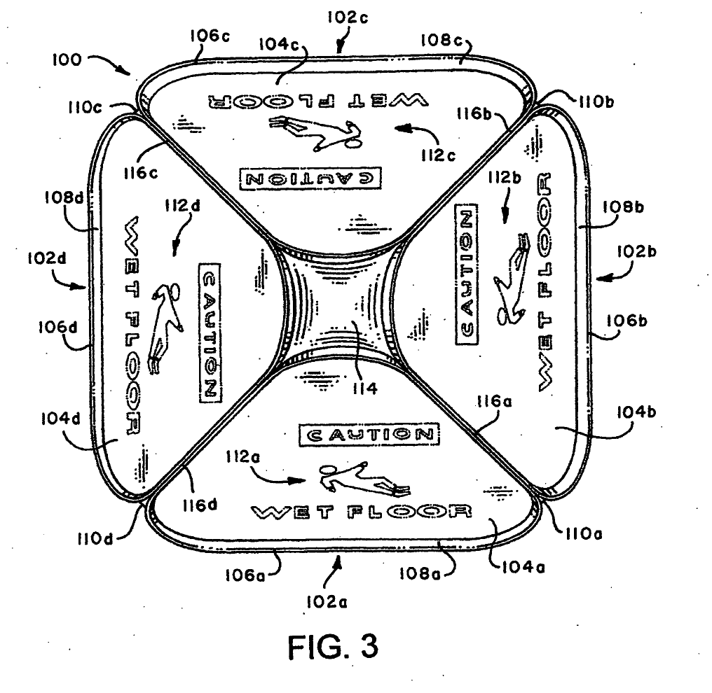

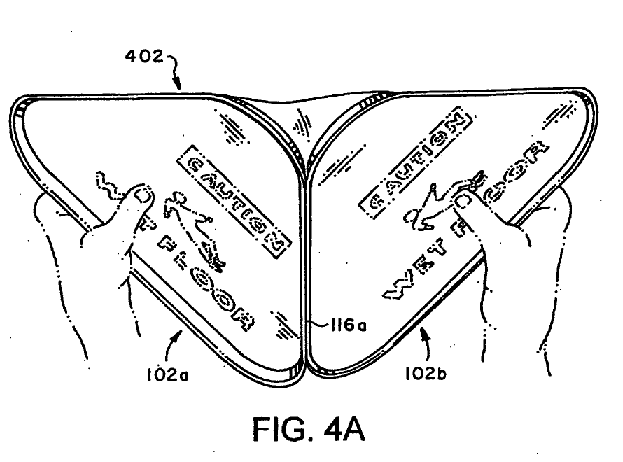

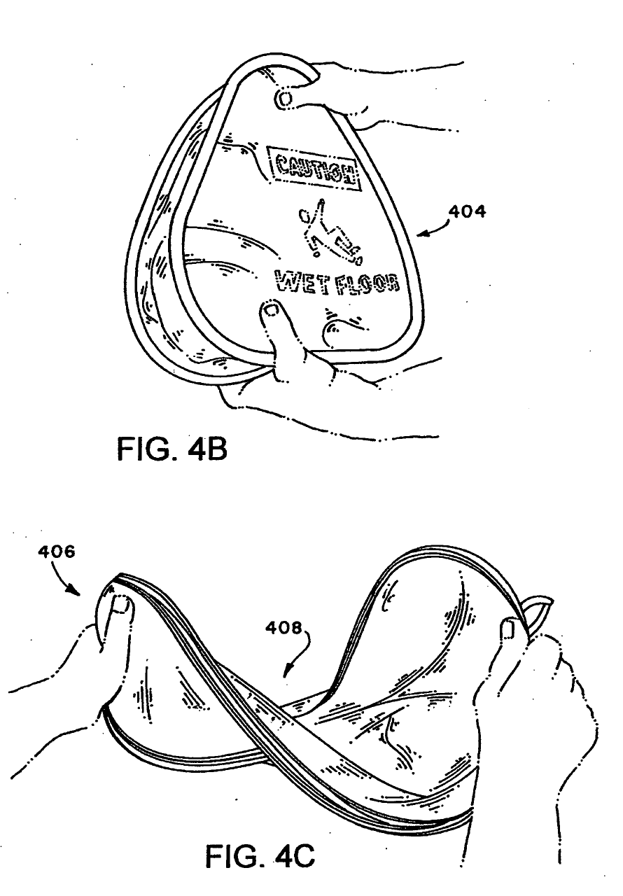

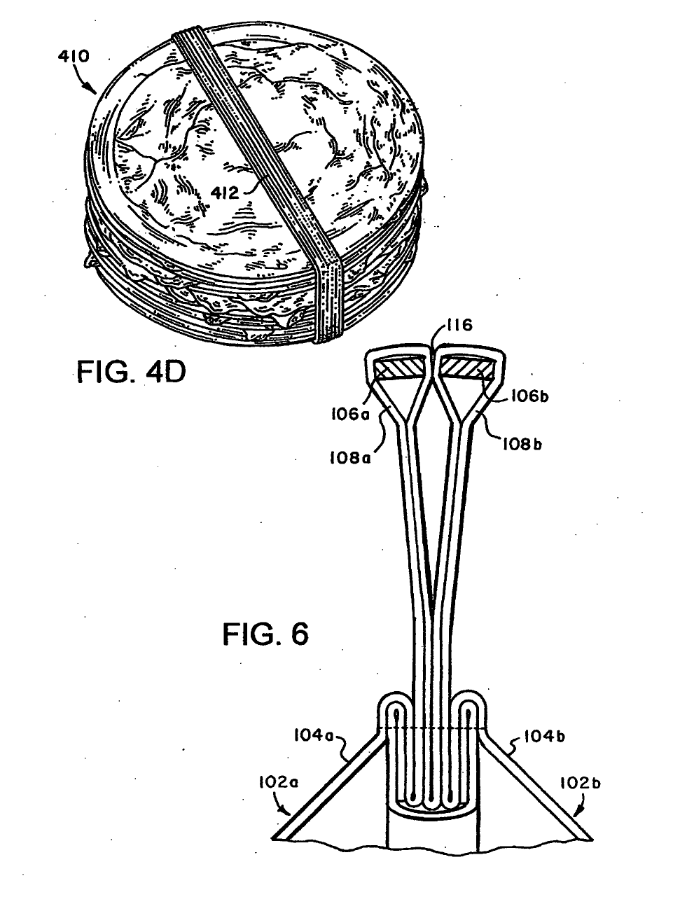

Referring to FIGS. 1-3, a collapsible portable structure according to an embodiment of the present invention is shown. Collapsible portable structure 100 includes at least three side panels 102a, 102b and 102c that are connected or held together. Collapsible portable structure 100 is configured such that in an expanded or non-collapsed position, the at least three side panels 102a, 102b and 102c are connected or held together to form an interior space defined by the at least three side panels 102a, 102b and 102c with an open bottom. Collapsible portable structure 100 is further configured such that in a collapsed position, the collapsible portable structure 100 has a compact generally circular shape that is reduced in size, as shown in FIG. 4D. In one embodiment, collapsible portable structure 100 in a collapsed position is reduced in size such that it may be carried at all relevant times by a user. Collapsible portable structure 100 may optionally include more than three side panels 102a, 102b and 102c. For instance, collapsible portable structure 100 may include a fourth side panel 102d, as shown in FIGS. 1 and 3. Collapsible portable structure 100 may optionally include top panel 114 to interconnect top portions of side panels 102a, 102b, 102c and 102d. Side panels 102a, 102b, 102c and 102d, and top panel 114 may be connected using any conventional manner including, but not limited to, stitching, weaving, joining, sealing, gluing, buttoning, zippering and hooking.

Side panels 102a, 102b, 102c and 102d are respectively formed by resilient materials 104a, 104b, 104c and 104d that substantially cover collapsible frame members 106a, 106b, 106c and 106d. In one embodiment, each of the collapsible frame members 106a, 106b, 106c and 106d has three edges connected by curved portions to form a generally triangular shape, as shown in FIGS. 1-3. In this configuration, each side panel 102a, 102b, 102c and 102d is connected to adjacent side panels 102a, 102b, 102c and 102d at first and second edges of the generally triangular shape, shown as 116a, 116b, 116c and 116d in FIGS. 1 and 3. The third edge of each side panel 102a, 102b, 102c and 102d substantially rests on the surface to support the collapsible portable structure 100. For instance, side panel 102a is connected to side panel 102d at a first edge 116d, and side panel 102 is connected to side panel 102a at a second edge 116a. The remaining edge of the generally triangular shape of side panel 102a substantially rests on the surface. Collapsible portable structure 100 may optionally take a variety of external shapes within the scope of the present invention. For instance, non-triangular shapes are possible including, but not limited to, rectangular, trapezoidal, octagonal, hexagonal, circular, oval and elliptical shapes. Collapsible portable structure 100 may optionally include bottom members 110a, 110b, 110c and 110d resting on the surface and used to respectively interconnect lower portions of side panels 102a and 102b, 102b and 102c, 102c and 102d, and 102d and 102a. Lower portions 110a, 110b, 110c and 110d may be configured to extend to the surface and/or to provide additional support to the collapsible portable structure 100, when the collapsible frame members are in the expanded position. The shape, size and number of bottom members 110a, 110b, 110c and 110d depend on the shape, size, and number of side panels 102a, 102b, 102c and 102d.

Referring to FIGS. 5 and 6, partially broken away section and cross-section views of a collapsible portable structure showing collapsible frame members according to an embodiment of the present invention are shown. Collapsible frame members 106a, 106b, 106c and 106d are respectively retained in position by resilient materials 104a, 104b, 104c and 104d which respectively include retaining sleeves 108a, 108b, 108c and 108d. Retaining sleeves 108a, 108b, 108c and 108d may be stitched, woven, joined, sealed, glued, buttoned, zippered, hooked or connected in any conventional manner to resilient materials 104a, 104b, 104c and 104d. Optionally, retaining sleeves 108a, 108b, 108c and 108d may be an extending portion of resilient materials 104a, 104b, 104c and 104d.

Resilient materials 104a, 104b, 104c and 104d, retaining sleeves 108a, 108b, 108c and 108d, top panel 114, and bottom members 110a, 110b, 110c and 110d may be composed of any flexible material including, but not limited to, fabric, nylon, mesh, netting, polymer sheets, paper and plastic. Retaining sleeves 108a, 108b, 108c and 108d may also be composed of other non-flexible materials including, but not limited to, metal and graphite, configured in the form of multiple rings, hooks, combs and/or springs. Optionally, all or portions of resilient materials 104a, 104b, 104c and 104d and/or message area portions 112a, 112b, 112c and 112d may be composed of fluorescent or glow-in-the-dark materials and/or reflective materials to aid in the visibility of the collapsible portable structure 100 or any portion thereof. Collapsible portable structure 100 may optionally include a bottom panel interconnecting bottom portions of side panels 102a, 102b, 102c and 102d at the surface such that the interior space is not open to the surface. In one embodiment, resilient materials 104a, 104b, 104c and 104d are free of openings that cover a substantial portion of the resilient material and that are configured to be used as an entry into an interior space formed by side panels 102a, 102b, 102c and 102d.

Collapsible portable structure 100 may be configured as a portable free-standing sign. In this embodiment, one or more side panels 102a, 102b, 102c and 102d include message area portions 112a, 112b, 112c and 112d, respectively. Optionally, top panel 114 may include a similar message area and/or a lighting mechanism, such as a detachable flashing light to aid in the visibility of the collapsible portable structure. Message area portions 112a, 112b, 112c and 112d may include letters and/or graphics. Message area portions 112a, 112b, 112c and 112d may be used to provide information, advertisements, general messages, and/or warning messages. Message area portions 112a, 112b, 112c and 112d may also include a flexible non-permanent writing surface. Flexible non-permanent writing surface includes, but is not limited to, 3M Post-it® Self-Stick Easel Wall Pads. Obviously, other nonpermanent equivalents are well known in the art.

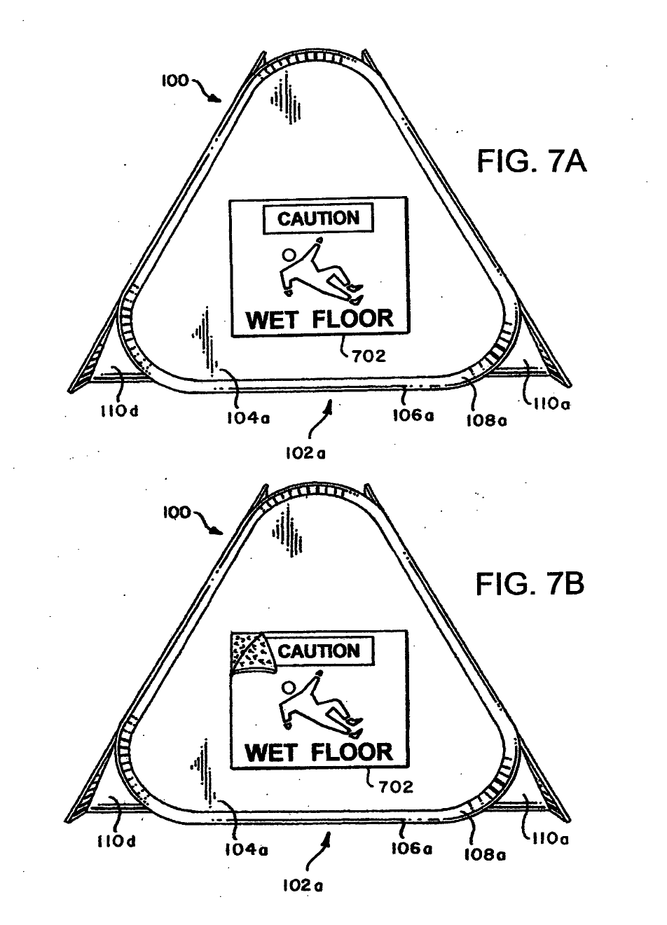

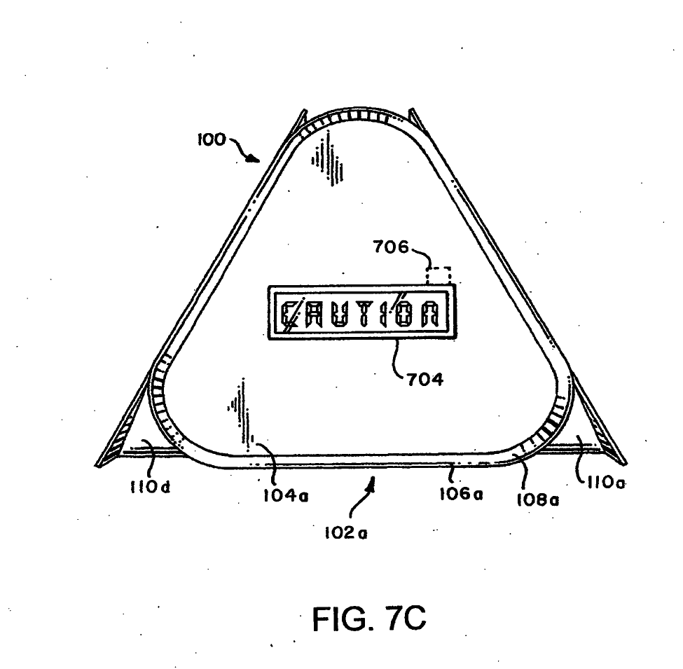

Referring to FIGS. 7A-7C, elevation side views of collapsible portable structures showing detachable message area portions according to other embodiments of the present invention are shown. In these embodiments, message area portions 702 and 704 may be detachably affixed to one or more side panels 102a, 102b, 102c and 102d, such that message area portions 702 and 704 may be removed and/or replaced (e.g., as shown in FIG. 7B), using any conventional mechanism including, but not limited to, Velcro, magnets, pins, clips, buttons, and suction. Message area portion 702 may be composed of any flexible material including, but not limited to, fabric, nylon, mesh, netting, polymer sheets, paper and plastic. Message area portion 702 may also be composed of any non-flexible material including, but not limited to, a hardened plastic, glass, metal and graphite. Optionally, message area portions 702 and 704 may include a non-permanent writing surface or other messaging area including, but not limited to, an erasable marker board, a chalk board, and an electronic digital board (e.g., LED display). For instance, an electronic digital board 704 as a detachable message area is shown in FIG. 7B. In this configuration, collapsible portable structure 100 may optionally include a wireless receiver 706 configured to receive electronic updates for electronic digital board 704. Thereby, message area portions 702 and 704 may be used to provide different and configurable information, advertisements, general messages and/or warning messages depending upon the desired need and conditions.

Referring to FIGS. 4A-4D, illustrations of a collapsible portable structure 100 showing transitions to a collapsed position and a fully collapsed position according to an embodiment of the present invention are shown. Collapsible portable structure 100 may be collapsed into a first transition position 402 by pushing in side panels 102a and 102b at edge 116a such that the interior space defined by the side panels 102a, 102b, 102c and 102d in the expanded position is substantially eliminated and edge 116a touches or is in close proximity to edge 116c, as shown in FIG. 4A. Side panels 102c and 102d are then folded together into a second transition position 404 such that edge 11 6b touches or is in close proximity to edge 11 6d, as shown in FIG. 4B. Collapsible portable structure 100 is then twisted and folded, at a middle portion 408, into a third transition position 406, as shown in FIG. 4C. Finally, collapsible structure 100 is transitioned into fully collapsed position 410, as shown in FIG. 4D. Collapsible portable structure 100 has a compact generally circular shape in its fully collapsed position 410 that is reduced in size from the collapsible portable structure 100 in its expanded or non-collapsed position. Optionally, a flexible retaining strap 412 may be used to hold and retain collapsible portal structure 100 in its collapsed position 410.

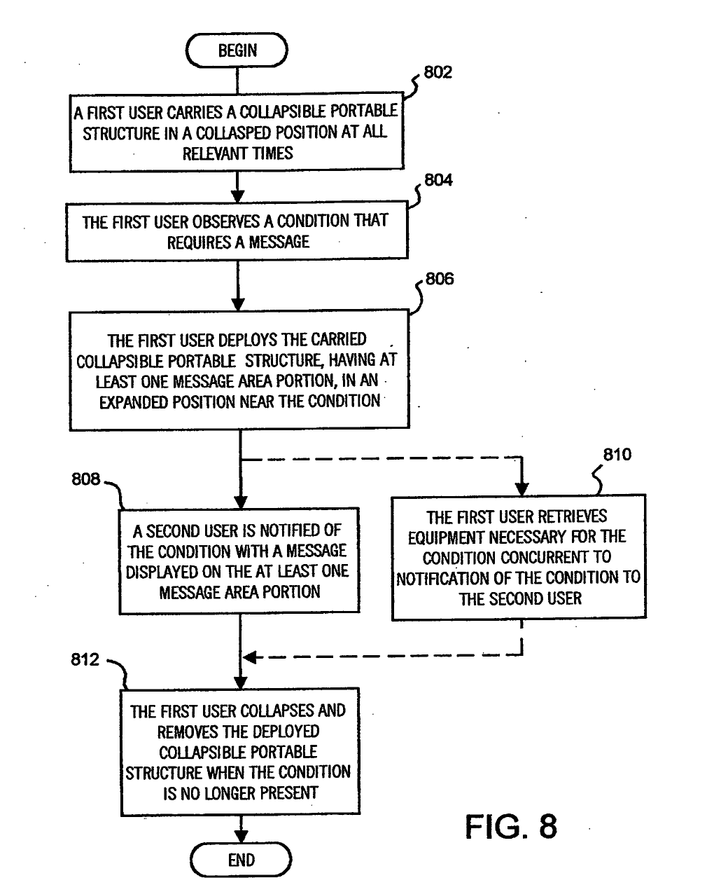

Referring to FIG. 8, a flow chart illustrating a process for using the collapsible portable structure 100 according to an embodiment of the present invention is shown. As shown at block 802, a first user carries a collapsible portable structure 100 in a collapsed position at all relevant times. For instance, the collapsible portable structure 100 may be carried in the first user's pant or shop pocket, or otherwise attached to or carried by the first user. The first user observes a condition that requires a message, as shown at block 804. As shown at block 806, the first user expands and deploys the carried collapsible portable structure 100, having at least one message area portion 112a, 112b, 112c and 112d, in an expanded position near the condition. A second user is notified of the condition with a message displayed on the at least one message area portion 112a, 112b, 112c and 112d, as shown at block 808. As shown at block 812, the first user collapses and removes the deployed collapsible portable structure when the condition is no longer present. The collapsible portable structure 100 may be removed by returning the collapsible portable structure 100 in its collapsed position back to the first user's normal carrying location, such as the first user's pant or shop pocket. Optionally, the first user retrieves the equipment necessary for the condition concurrent to the notification of the condition to the second user, as shown at block 810.

In a non-limiting example, an employee carries one or more collapsible portable structures 100 in a collapsed position at all relevant times, such as substantially at all times when the employee is on duty until the employee deploys the collapsible portable structure 100 in an expanded position. The employee observes a condition that requires a message, such as a spill or other hazard. Immediately upon observation of condition, the employee quickly retrieves one or more carried collapsible portable structures 100, such as from the employee's pant or shop pocket, and expands and deploys the one or more collapsible portable structures 100 in an expanded position near the condition. For instance, the employee could deploy the collapsible portable structure 100 over the spill or other hazard, or the employee could deploy one or more collapsible portable structures 100 on the isle where the spill or other hazard occurred. The employee then retrieves the equipment necessary for the condition, such as a mop. During the period of time required for the employee to retrieve the equipment necessary for the condition and to remove the condition, any customer approaching the condition would be warned of the condition. For instance, any customer approaching a spill or other hazard would be warned of the spill or other hazard during the period of time required for the employee to retrieve a mop, and to mop the spill or otherwise remove the hazard. Thereby, the care and safety of the customer is improved regarding the condition.

In another non-limiting example, a meeting manager could deploy a collapsible portable structure 100 to notify attendees of a scheduled event of a room change or other valuable information. In yet another non-limiting example, the collapsible portable structure 100 could be deployed to temporarily redirect the flow of pedestrian traffic in an area or to provide other valuable information. For instance, the collapsible portable structure 100 could be deployed as a temporary sign for messaging and/or advertising purposes.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise than as specifically described. For instance, although four generally triangular side panels 102a, 102b, 102c and 102d, top panel 114, and bottom members 110a, 110b, 110c and 110d are discussed and shown in FIGS. 1-3, this configuration is used for illustrative purposes only and is not intended to limit the possible configurations of the present invention in any way.

1. A collapsible portable structure, comprising:
at least three collapsible frame members, each collapsible frame member having a collapsed position and an expanded position, each collapsible frame member having three or more edges defining a continuous loop in the expanded position;
a resilient material substantially covering each collapsible frame member to form a side panel for each collapsible frame member;
a hinge portion hingedly connecting each of the collapsible frame members, a first edge of each collapsible frame member being hingedly connected to a second edge of a first adjacent frame member, and the second edge of each collapsible frame member being hingedly connected to the first edge of a second adjacent frame member; and
wherein the collapsible frame members and their associated side panels are connected together such that an interior space is formed between the side panels and a third edge of each collapsible frame member substantially rests on the surface to support the collapsible portable structure, when the collapsed frame members are in the expanded position, and wherein at least one of the side panels includes a message area portion.

2. The collapsible portable structure of claim 1, wherein the collapsible portable structure comprises a self-standing structure when the collapsed frame members are in the expanded position.

3. The collapsible portable structure of claim 1, wherein the collapsible frame member includes three edges defining a generally triangular shape in the expanded position.

4. The collapsible portable structure of claim 1, wherein the collapsible frame member includes four edges defining a generally rectangular shape in the expanded position.

5. The collapsible portable structure of claim 1, wherein the resilient material of each side panel is free of openings of a substantial portion of the resilient material.

6. The collapsible portable structure of claim 1, wherein the resilient material of each side panel comprises at least one of a fluorescent material and a reflective material.

7. The collapsible portable structure of claim 1, wherein the at least three collapsible frame members comprise four collapsible frame members.

8. The collapsible portable structure of claim 1, wherein the third edge of each collapsible frame member define an opening to the interior space.

9. The collapsible portable structure of claim 1, wherein each hinge portion is attached to a substantial portion of the first and second edges of the respective collapsible frame members.

10. The collapsible portable structure of claim 9, wherein each hinge portion comprises a sleeve containing substantial portions of respective edges of two collapsible frame members.

11. The collapsible portable structure of claim 9, wherein each hinge portion comprises substantially connected first and second sleeves, wherein the first sleeve contains a substantial portion of the first edge of the collapsible frame member, and the second sleeve contains a substantial portion of the second edge of the collapsible frame member.

12. The collapsible portable structure of claim 1, wherein the resilient material comprises a fabric.

13. The collapsible portable structure of claim 1, wherein the resilient material comprises a mesh.

14. The collapsible portable structure of claim 1, wherein the resilient material comprises at least one of a fabric, a nylon material, a mesh, a netting, a polymer sheet, a paper sheet and a flexible plastic material.

15. The collapsible portable structure of claim 1, wherein the collapsible portable structure is configured to be carried by a user at all relevant times when the collapsed frame members are in the collapsed position.

16. The collapsible portable structure of claim 15, wherein the collapsible portable structure fits into a user pant or shop pocket when the collapsed frame members are in the collapsed position.

17. The collapsible portable structure of claim 1, further comprising a resilient material bottom panel connecting a lower portion of each of the frame members, wherein a first resilient material bottom panel connects a lower portion of first edge of each collapsible frame member to a lower portion of the second edge of the first adjacent frame member, and a second resilient material bottom panel connects a lower portion of second edge of each collapsible frame member to a lower portion of the first edge of the second adjacent frame member.

18. The collapsible portable structure of claim 17, wherein an edge of each resilient material bottom panel substantially rests on the surface.

19. The collapsible portable structure of claim 1, wherein each message area portion comprises an advertisement.

20. The collapsible portable structure of claim 1, wherein each message area portion comprises a warning message.

21. The collapsible portable structure of claim 1, wherein each message area portion comprises a message area member that is detachably attached to the at least one side panel.

22. The collapsible portable structure of claim 21, wherein message area member is detachably attached to the at least one side panel using at least one of Velcro, magnets, pins, clips, buttons and suction.

23. The collapsible portable structure of claim 22, wherein each message area member comprises a nonpermanent writing surface.

24. The collapsible portable structure of claim 22, wherein each message area member comprises an electronic digital display.

25. The collapsible portable structure of claim 1, wherein each message area portion is configurable by a user.

26. The collapsible portable structure of claim 25, wherein each message area portion comprises a flexible nonpermanent writing surface.

27. The collapsible portable structure of claim 1, further comprising a top panel interconnecting top portions of each side panel, and a bottom portion interconnection bottom portions of each side panel at the surface, wherein the interior space is substantially enclosed by the side panels, the top panel and the bottom portions.

28. The collapsible portable structure of claim 1, wherein the collapsible frame members are non-overlapping when the collapsed frame members are in the expanded position.

29. A collapsible portable structure, comprising:
at least three collapsible frame members, each collapsible frame member having a collapsed position and an expanded position, each collapsible frame member defining a continuous loop in the expanded position;
a resilient material substantially covering each collapsible frame member to form a side panel for each collapsible frame member;
means for connecting each collapsible frame member to adjacent collapsible frame members; and
wherein the collapsible frame members and their associated side panels are connected together such that an interior space is formed between the side panels and a third edge of each collapsible frame member substantially rests on the surface to support the collapsible portable structure, when the collapsed frame members are in the expanded position, and wherein at least one of the side panels includes a message area portion.

30. The collapsible portable structure of claim 29, wherein the collapsible portable structure comprises a self-standing structure when the collapsed frame members are in the expanded position.

31. The collapsible portable structure of claim 30, wherein the collapsible frame member includes three edges defining a generally triangular shape in the expanded position.

32. The collapsible portable structure of claim 30, wherein the collapsible frame member includes four edges defining a generally rectangular shape in the expanded position.

33. The collapsible portable structure of claim 30, wherein the collapsible frame member generally defines a circular shape in the expanded position.

34. The collapsible portable structure of claim 31, wherein the resilient material of each side panel is free of openings of a substantial portion of the resilient material.

35. The collapsible portable structure of claim 31, wherein the resilient material of each side panel comprises at least one of a fluorescent material and a reflective material.

36. The collapsible portable structure of claim 31, wherein the resilient material comprises at least one of a fabric, a nylon material, a mesh, a netting, a polymer sheet, a paper sheet and a flexible plastic material.

37. The collapsible portable structure of claim 31, wherein the collapsible portable structure is configured to be carried by a user at all relevant times when the collapsed frame members are in the collapsed position.

38. The collapsible portable structure of claim 37, wherein the collapsible portable structure fits into a user pant or shop pocket when the collapsed frame members are in the collapsed position.

39. The collapsible portable structure of claim 31, wherein each message area portion comprises an advertisement.

40. The collapsible portable structure of claim 31, wherein each message area portion comprises a warning message.

41. The collapsible portable structure of claim 31, wherein each message area portion comprises a message area member that is detachably attached to the at least one side panel.

42. The collapsible portable structure of claim 41, wherein the message area member is detachably attached to the at least one side panel using at least one of Velcro, magnets, pins, clips, buttons and suction.

43. The collapsible portable structure of claim 42, wherein each message area member comprises a nonpermanent writing surface.

44. The collapsible portable structure of claim 42, wherein each message area member comprises an electronic digital display.

45. The collapsible portable structure of claim 31, wherein each message area portion is configurable by a user.

46. The collapsible portable structure of claim 45, wherein each message area portion comprises a flexible nonpermanent writing surface.

47. The collapsible portable structure of claim 31, further comprising a top panel interconnecting top portions of each side panel, and a bottom portion interconnection bottom portions of each side panel at the surface, wherein the interior space is substantially enclosed by the side panels, the top panel and the bottom portions.

48. The collapsible portable structure of claim 31, wherein the collapsible frame members are non-overlapping when the collapsed frame members are in the expanded position.

49. A method for providing notice of a condition using a collapsible portable structure, comprising:
carrying a collapsible portable structure comprising at least three collapsible frame members, a resilient material substantially covering each collapsible frame member to form a side panel for each collapsible frame member, and means for connecting each collapsible frame member to adjacent collapsible frame members, wherein each collapsible frame member defines a continuous loop, at least one of the side panels includes a message area portion, each collapsible frame member has a collapsed position and an expanded position, and the collapsible portable structure is carried in the collapsed position at all relevant times by a first user;
observing a condition requiring a message;
deploying the carried collapsible portable structure in an expanded position, wherein the collapsible frame members and their associated side panels are connected together such that an interior space is formed between the side panels and a third edge of each collapsible frame member substantially rests on the surface to support the collapsible portable structure, when the collapsed frame members are in the expanded position; and
notifying a second user of the condition with a message displayed on the message area portion.

50. The method of claim 49, wherein the collapsible portable structure fits into the first user pant or shop pocket when the collapsed frame members are in the collapsed position.

51. The method of claim 50, wherein the condition comprises a liquid spill and the message comprises a hazard warning.

52. The method of claim 51, further comprising retrieving equipment necessary to clean the liquid spill, wherein the equipment is retrieved concurrent to the notification of the condition to the second user.

53. The method of claim 50, further comprising collapsing and removing the collapsible portable structure when the condition is no longer present.

54. The method of claim 53, wherein removing the collapsible portable structure comprises placing the collapsible portable structure into the first user pant or shop pocket when the collapsed frame members are in the collapsed position.
